(19) United States
(12) Patent Application Publication
(10) Pub. No.: US 2025/0091239 A1
(43) Pub. Date: Mar. 20, 2025

(54) PROCESSING DEVICE FOR PROCESSING OPPOSING EDGES OF A FLEXIBLE SHEET BODY

(71) Applicant: Chun-Fu KUO, Taichung (TW)

(72) Inventor: Chun-Fu KUO, Taichung (TW)

(21) Appl. No.: 18/968,113

(22) Filed: Dec. 4, 2024

Related U.S. Application Data
(63) Continuation-in-part of application No. 17/471,401, filed on Sep. 10, 2021.

(51) Int. Cl. B26D 7/01; B26D 1/04; B26D 11/00

(52) U.S. Cl. CPC B26D 7/018; B26D 1/045; B26D 11/00

(57) ABSTRACT

A processing device for processing opposing edges of a flexible sheet body is provided, including: a base; a first suction mechanism, arranged on the base and extending along a first direction, including first suction openings; at least one second suction mechanism, arranged on the base and extending in parallel with the first suction mechanism, including second suction openings, the at least one second suction mechanism and the first suction mechanism being relatively movable; a support platform, being adjustable and located between the first suction mechanism and the at least one second suction mechanism; at least one rail mechanism, arranged on the base; at least one gantry mechanism, movably arranged on the at least one rail mechanism; and at least two cutting mechanisms, arranged on the at least one gantry mechanism, at least one of the at least two cutting mechanisms being movable in a second direction.

### BACKGROUND OF THE INVENTION

### Field of the Invention

The present invention is a CIP of application Ser. No. 17/471,401, filed Sep. 10, 2021, the entire contents of which are hereby incorporated by reference.

### Description of the Prior Art

In many fields, flexible sheet bodies such as sheets or cushions are often used as buffers, anti-skid and/or other purposes. The sheets or cushions are preferably made of soft materials (such as rubber, plastic foam materials). According to different needs, the edges of the sheets or cushions are usually processed (with cutting, beveling or the like) or/and welted.

However, in the conventional method of processing the edges of the flexible sheet body, the flexible sheet body is generally placed directly on a fixed and non- adjustable platform, and then the edges of the flexible sheet body are respectively processed one by one. Before each processing of the edge, the flexible sheet body must be moved and turned on the fixed platform to make the next-processed edge correspond to processing tool. Since the flexible sheet body itself is easy deformable and the error and inaccuracy are caused because of the movement and turning of the flexible sheet body, so the processing of opposing edges of the flexible sheet body cannot be carried out in high accuracy, precision and parallelism.

In addition, the flexible sheet body has a need for welting or other surface processing. For example, in the conventional process, it is often to attach strips to the edges of the flexible sheet body, respectively, by using a strip-attaching device after the edges of the flexible sheet body are processed. However, there are some accuracy and parallelism errors during the processing of the edges of the flexible sheet body, and the later surface processing processes also cause considerable errors, so the conventional process cannot meet the requirements of high accuracy and parallelism of the edges of the flexible sheet body.

US2012/0152079 discloses that none of strip-attaching mechanisms and one cutting mechanism are synchronously movable along the same rail mechanism, such that it is not capable of attaching any strip on and along at least one of the opposing edges of the flexible sheet body during the single one cutting mechanism disposed on the respective gantry cut the opposing edges of the flexible sheet body. As a result, the processing of opposing edges of the flexible sheet body cannot be carried out in high accuracy, precision and parallelism. Most important, in US2012/0152079, a cover sheet covers a substrate such as a glass substrate or semiconductor wafer to protect its surface (paragraph [0004]), and a cover sheet 2 covers the substrate 1 (paragraph [0036]). It is noted that the substrate 1 is hard but not flexible and cannot be regarded as a flexible sheet body. Additionally, paragraph and FIG. 17 describe that the press members 33gently presses the end portions of the substrate 1 against the periphery holding units 60. In this pressed state, the apparatus sets the periphery suction portions 62 and the center suction portion 72 in a suction state to hold the substrate 1. That is, the periphery suction portions 62 suck the substrate 1 but not suck the cover sheet 2. In fact, the periphery suction portions 62 cannot suck the cover sheet 2 because the objective of US2012/0152079 is to trim the cover sheet 2 throughout the entire periphery of the substrate (paragraph [0006]).

Similarly, US2012/0210839 discloses that none of strip-attaching mechanisms and one cutting mechanism are synchronously movable along the same rail mechanism, such that it is not capable of attaching any strip on and along at least one of the opposing edges of the flexible sheet body during the single one cutting mechanism disposed on the respective gantry cut the opposing edges of the flexible sheet body.

In U.S. Pat. No. 3,682,750, column 2, line 65 to column 2, line 2, as the blade 20 advances in cutting engagement with the layup 14, a slit or cut 22 is formed through which air may pass to the surface of the vacuum hold-down table 12 causing a loss of vacuum and a resulting loss of table holding efficiency. In accordance with the present invention, the apparatus 10 is provided with a sealing device indicated generally at 24 for dispensing a quantity of sealing material 26 as the cutter advances to substantially seal an associated portion of the slit 22 formed by the cutter to prevent passage of air therethrough. The sealing material 26 is not to be attached to and not to be remained on the cut surfaces of the layup 14.

In U.S. Pat. No. 7,669,839, the vacuum passage 18 includes a deep portion and a shallow portion, the deep portion is disposed through the vacuum cup 10b, and the shallow portion has a depth more than 0.80 times the thickness of the vacuum cup 10b (FIG. 6A). As such, the work piece does not be sucked to abut on the bottom of the vacuum passage 18 and to abut on the bottom of the trench 14. In fact, the work piece cannot be sucked to abut on the bottom of the vacuum passage 18 and cannot abut on the bottom of the trenches 14 since this will discommunicate the trenches 14 from the vacuum passage 18, which will make the vacuum function fail.

The present invention is, therefore, arisen to obviate or at least mitigate the above-mentioned disadvantages.

### SUMMARY OF THE INVENTION

The main object of the present invention is to provide a processing device for processing opposing edges of a flexible sheet body, with high processing accuracy, high parallelism, and high processing efficiency.

To achieve the above and other objects, a processing device for processing opposing edges of a flexible sheet body is provided, including: a base, defining a first direction and a second direction, the first direction being defined as a processing direction, the second direction being lateral to the first direction; a first suction mechanism, arranged on the base and extending along the first direction, including a plurality of first suction openings arranged along the first direction, configured to support and suck the flexible sheet body; at least one second suction mechanism, arranged on the base and extending in parallel with the first suction mechanism, including a plurality of second suction openings arranged along the first direction, the at least one second suction mechanism and the first suction mechanism being relatively movable in the second direction, the at least one second suction mechanism being configured to support and suck the flexible sheet; a support platform, being adjustable and located between the first suction mechanism and the at least one second suction mechanism, configured to support the flexible sheet body; at least one rail mechanism, arranged on the base and extending along the first direction; at least one gantry mechanism, arranged on the at least one rail mechanism and movable along the first direction; and at least two cutting mechanisms, arranged on the at least one gantry mechanism and configured to cut the opposing edges of the flexible sheet body in parallel, at least one of the at least two cutting mechanisms being movable in the second direction.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of a preferable embodiment of the present invention;

FIG. 2 is a partial enlarged stereogram of a preferable embodiment of the present invention;

FIG. 3 is a partial enlargement of FIG. 2;

FIG. 4 is another partial enlarged stereogram of a preferable embodiment of the present invention;

FIG. 5 is a partial enlargement of a first suction mechanism of the present invention;

FIG. 6 is a cross-sectional view of FIG. 5;

FIG. 7 is a partial enlargement of a second suction mechanism of the present invention;

FIG. 8 is a cross-sectional view of FIG. 7;

FIG. 9 is a drawing showing a flexible sheet body which is sucked and supported according to a preferable embodiment of the present invention; and

FIG. 10 is a partial enlargement of FIG. 9.

### DETAILED DESCRIPTION OF THE PREFERRED EMBODIMENTS

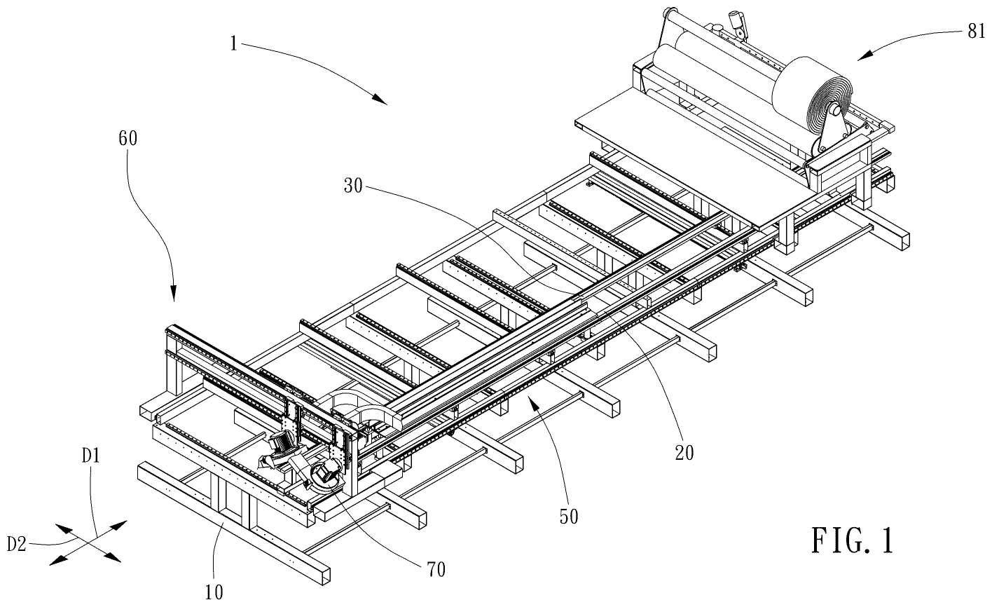

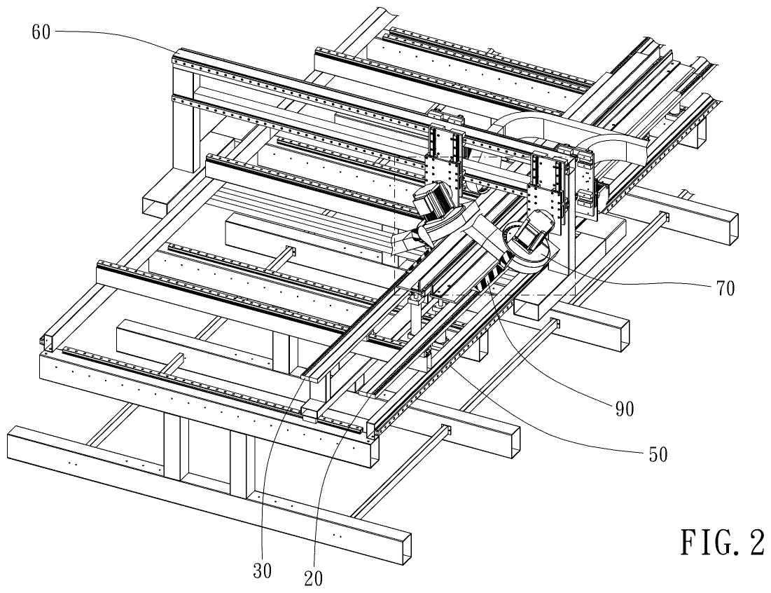

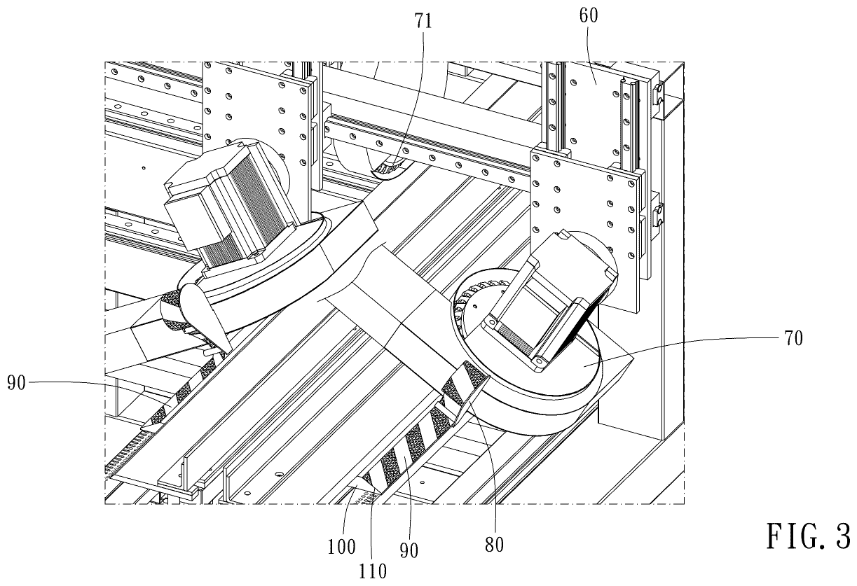

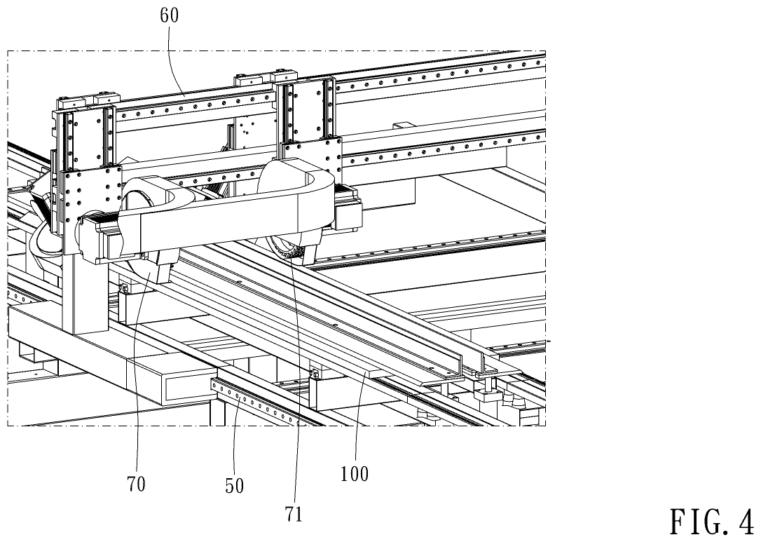

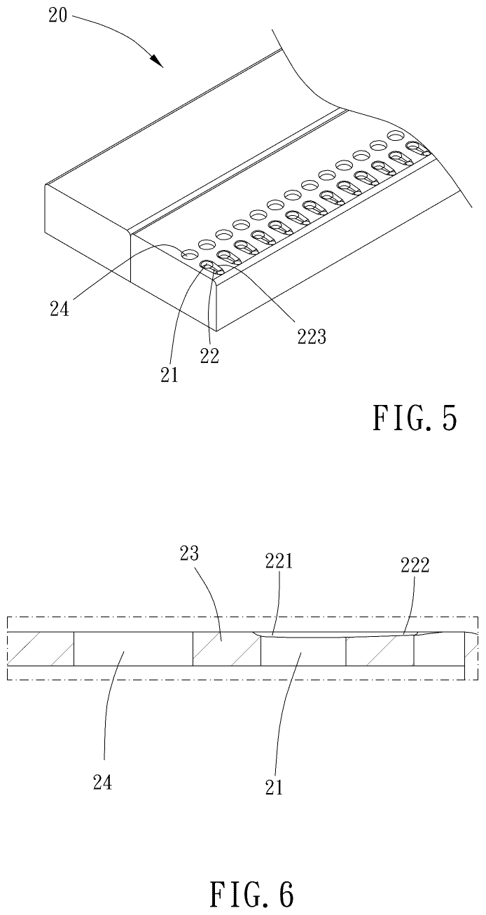

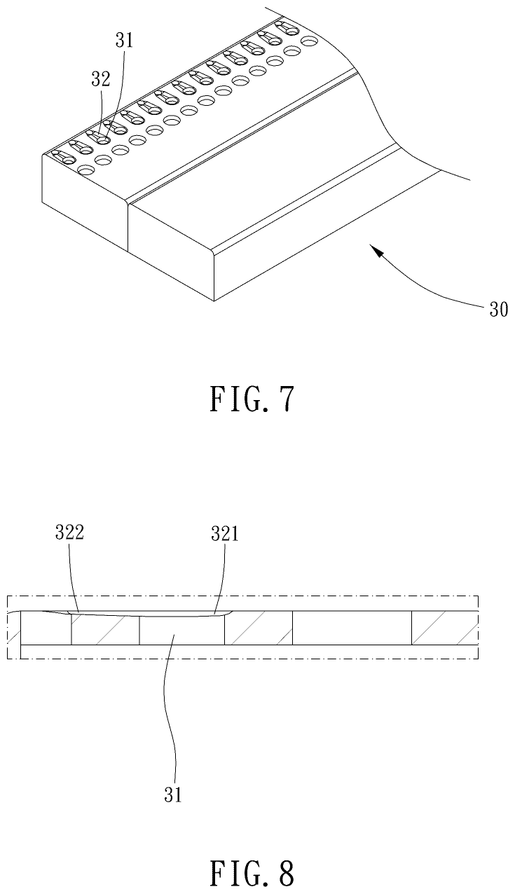

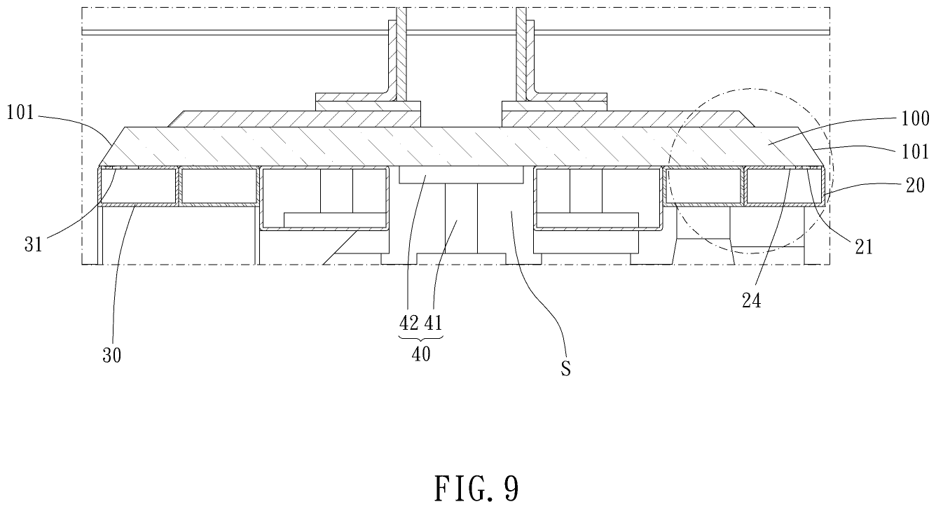

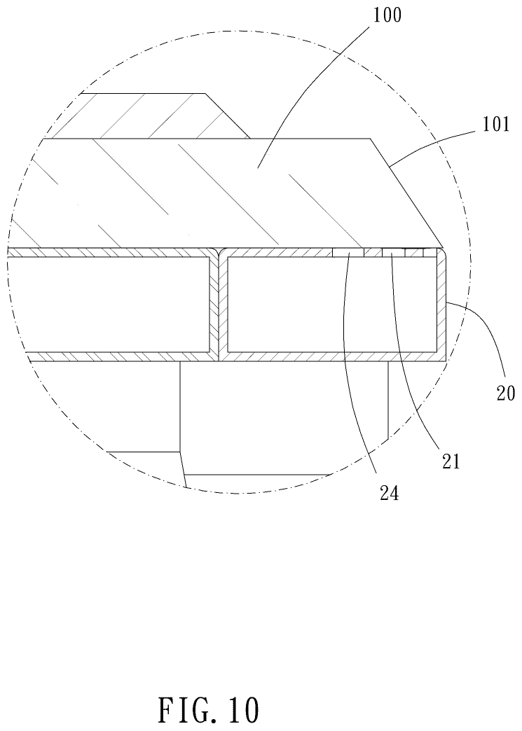

Please refer to FIGS. 1 to 10 for a preferable embodiment of the present invention. A processing device 1 for processing opposing edges of a flexible sheet body 100 of the present invention includes a base 10, a first suction mechanism 20, at least one second suction mechanism 30, a support platform 40, at least one rail mechanism 50, at least one gantry mechanism 60 and at least two cutting mechanisms 70.

The base 10 defines a first direction D1 and a second direction D2, the first direction D1 is defined as a processing direction, and the second direction D2 is lateral to the first direction D1. The first suction mechanism 20 is arranged on the base 10 and extends along the first direction D1, the first suction mechanism 20 includes a plurality of first suction openings 21 arranged along the first direction D1, and the first suction mechanism 20 is configured to support and suck the flexible sheet body 100. The at least one second suction mechanism 30 is arranged on the base 10 and extends in parallel with the first suction mechanism 20, the at least one second suction mechanism 30 includes a plurality of second suction openings 31 arranged along the first direction D1, the at least one second suction mechanism 30 and the first suction mechanism 20 are relatively movable in the second direction D2, and the at least one second suction mechanism 30 is configured to support and suck the flexible sheet body 100. The support platform 40 is adjustable and located between the first suction mechanism 20 and the at least one second suction mechanism 30, and the support platform 40 is configured to support the flexible sheet body 100. The at least one rail mechanism 50 is arranged on the base 10 and extends along the first direction D1. Preferably, the at least one rail mechanism 50 includes at least one linear rail or other guiding member. The at least one gantry mechanism 60 is arranged on the at least one rail mechanism 50 and movable along the first direction D1. The at least two cutting mechanisms 70 are arranged on the at least one gantry mechanism 60 and configured to cut the opposing edges 110 of the flexible sheet body 100 (preferably in parallel) to form two cut inclined surfaces 101, and at least one of the at least two cutting mechanisms 70 is movable in the second direction D2 so that it is flexible and easy to adjust processing position according to various sizes (length and/or width). When the first suction mechanism 20 and the at least one second suction mechanism 30 suck the flexible sheet body 100, the plurality of first suction openings 21 correspond to one of the two cut inclined surfaces 101 in a thickness direction of the flexible sheet body 100, and the plurality of second suction openings 31 correspond to an other of the two cut inclined surfaces 101 in the thickness direction of the flexible sheet body 100. As such, the opposing edges of the flexible sheet body 100 can be firmly held in position without displacement when processed so that the opposing edges of the flexible sheet body 100 can be processed with high processing accuracy, high parallelism, and high processing efficiency.

By suction of the first suction mechanism 20 and the at least one second suction mechanism 30, the flexible sheet body 100 can be stably positioned, the flexible sheet body 100 can be supported by the support platform 40 without sinking due to gravity, so that the at least two cutting mechanisms 70 can cut the opposing edges 110 of the flexible sheet body 100 with high processing accuracy, high parallelism, and high processing efficiency.

The first suction mechanism 20 and the at least one second suction mechanism 30 each have an interior chamber configured to be in communication with a vacuum device. The first suction mechanism 20 further includes a plurality of first recesses 22, the bottom of each of the plurality of first recesses 22 includes at least one said first suction opening 21, the first suction mechanism 20 further includes an upper wall 23, the plurality of first recesses 22 are disposed on the upper wall 23, at least part of the plurality of first recesses 22 includes a deep portion 221 and a shallow portion 222, depths of the deep portion 221 and the shallow portion 222 are less than or equal to 0.30 times a thickness of the upper wall 23, and at least some of the plurality of first suction openings 21 have different diametric dimensions. The deep portion 221 is gradually deeper from a periphery 223 of the first recess 22 to the at least one of the plurality of first suction openings 21, and the shallow portion 222 is gradually deeper from the periphery 223 of the first recess 22 to the at least one of the plurality of first suction openings 21, so that this allows the flexible sheet body 100 to be sucked to abut the bottom surface of the first recess 22 in a wide range and smoothly. The first suction mechanism 20 further includes a plurality of through holes 23 disposed through the upper wall 23, and the plurality of through holes 23 and the plurality of first suction openings 21 are arranged side by side along the first direction D1, so that this allows to suck the flexible sheet body 100 more firmly. The second suction mechanism 30 further includes a plurality of second recess 32, the bottom of each of the plurality of second recessed 32 includes at least one said second suction opening 31, at least part of the plurality of second recesses 32 includes a deep portion 321 and a shallow portion 322, and at least some of the plurality of second suction opening 31 have different diametric dimensions. The plurality of first recesses 22 and the plurality of second recesses 32 increase suction area of the flexible sheet body 100 and allow the flexible sheet body 100 to partially engage therewithin, which stably position the flexible sheet body 100. Preferably, the plurality of first recesses 22 and the plurality of second recesses 32 extend in a direction lateral to (for example, perpendicular to) the first direction D1 so that the flexible sheet body 100 can be kept in position and prevented from displacing due to drawing of processing tool(s) in the first direction D1.

Preferably, the first suction mechanism 20 and the at least one second suction mechanism 30 define a region S therebetween, and the support platform 40 is movable relative to the region S. In this embodiment, the support platform 40 includes a cylinder telescopic mechanism 41 and a support board 42 connected with the cylinder telescopic mechanism 41, the cylinder telescopic mechanism 41 is arranged on the base 10 and located relatively under the region S, the support board 42 is generally in parallel to the region S horizontally, the cylinder telescopic mechanism 41 can move close to or away from the region S, so that the position of the support board 42 to support the flexible sheet body 100 is adjustable so as to make the flexible sheet body 100 entirely flat without sinking of the flexible sheet body 100 due to gravity. As a result, the opposing edges 110 of the flexible sheet body 100 are not brought down and not wrapped and/or deformed, which improves processing accuracy and parallelism. In other embodiments, the support platform 40 may be a retractable or/and foldable mechanism which is movable in the first direction D1, which can be adjusted in length, width and/or position according to flexible sheet bodies with different sizes, for good support for the flexible sheet body.

Each of the two cutting mechanisms 70 includes a processing member 71 includes at least one of knife, saw and shaping grindstone, so the flexible sheet body can be processed by the processing member 71 having a suitable type of processing tool according to various conditions such as material, hardness and edge structural type to be processed. Preferably, each of the two cutting mechanisms 70 is angularly adjustable relative to at least one of the first direction D1 and the second direction D2, to process the flexible sheet body 100 to form different edge structures such as vertical edges, bevels or the like. As the at least two cutting mechanisms 70 includes more than three cutting mechanisms arranged on the at least one gantry mechanism 60 in the second direction D2, every neighboring two of the cutting mechanisms can be used to process one flexible sheet body; however, a plurality of cutting mechanisms may be arranged in the second direction D2 so as to process a plurality of flexible sheet body at the same time, which is of high processing efficiency.

A surface processing device 80, such as at least one strip-attaching mechanism, at least one printing mechanism or at least one laser engraving mechanism, is further arranged on the at least one gantry mechanism 60, to further process the surface of the flexible sheet body 100 according to various requirements. The surface processing is preferable carried out during the period of processing the opposing edges 110 of the flexible sheet body 100. Preferably, during a period when the first suction mechanism 20 and the at least one second suction mechanism 30 suck the opposing edges 110 of the flexible sheet body 100 and when the at least two cutting mechanisms 70 cut the opposing edges 110 of the flexible sheet body 100, at least one strip-attaching mechanism arranged on the at least one gantry mechanism 60 attaches at least one strip 90 on and along at least one of the opposing edges 110 of the flexible sheet body 100. Whereby, the flexible sheet body 100 can be cut in parallel by the at least two cutting mechanisms 70 under a very stable condition because of suction of the first suction mechanism 20 and the at least one second suction mechanism 30, which avoids many stages of cutting and processing so that it is of high processing accuracy, high parallelism, and high processing efficiency. Moreover, since the attachment of the strips 90 to the opposing edges 110 is carried out within the period when the opposing edges 110 is processed, the strips 90 are attached to the opposing edges 110 at the same time so that the strips 90 on the opposing edges 110 are provided with extremely high parallelism.

Preferably, at least one reel mechanism 81 is arranged on the at least one gantry mechanism 60, wherein the at least one reel mechanism 81 is configured to reel in or out the flexible sheet body 100. Preferably, the base 10, the first suction mechanism 20 and the second suction mechanism 30 are combinable with another said base 10, another said first suction mechanism 20 and another said second suction mechanism 30, respectively, so that an extent of the processing device is extendable, for processing a long flexible sheet body which is reeled on the at least one reel mechanism 81, thus ensuring extremely high parallelism of the opposing edges of the long flexible sheet body.

In sum, the processing device for processing the opposing edges of the flexible sheet body has the following advantages:
1. Specific design for processing a flexible sheet body, adjustable and flexible for processing the opposing edges.
2. capable of carrying out various processing procedures synchronously on the opposing edges in extremely high parallelism, high efficiency and high precision.
3. capable of meeting various requirements of processing on the opposing edges of flexible sheet bodies with various sizes and length.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A processing device for processing opposing edges of a flexible sheet body, including:
a base, defining a first direction and a second direction, the first direction being defined as a processing direction, the second direction being lateral to the first direction;
a first suction mechanism, arranged on the base and extending along the first direction, including a plurality of first suction openings arranged along the first direction, configured to support and suck the flexible sheet body;
at least one second suction mechanism, arranged on the base and extending in parallel with the first suction mechanism, including a plurality of second suction openings arranged along the first direction, the at least one second suction mechanism and the first suction mechanism being relatively movable in the second direction, the at least one second suction mechanism being configured to support and suck the flexible sheet;
a support platform, being adjustable and located between the first suction mechanism and the at least one second suction mechanism, configured to support the flexible sheet body;
at least one rail mechanism, arranged on the base and extending along the first direction;
at least one gantry mechanism, arranged on the at least one rail mechanism and movable along the first direction; and
at least two cutting mechanisms, arranged on the at least one gantry mechanism and configured to cut the opposing edges of the flexible sheet body in parallel to form two cut inclined surfaces, at least one of the at least two cutting mechanisms being movable in the second direction;
wherein when the first suction mechanism and the at least one second suction mechanism suck the flexible sheet body, the plurality of first suction openings correspond to one of the two cut inclined surfaces in a thickness direction of the flexible sheet body, and the plurality of second suction openings correspond to an other of the two cut inclined surfaces in the thickness direction of the flexible sheet body;
wherein two strip-attaching mechanisms and two of the at least two cutting mechanisms are arranged on the at least one gantry mechanism arranged on one of the at least one rail mechanism, each of the at least two cutting mechanisms includes a cutter, and one of the two strip- attaching mechanisms and one of the two of the at least two cutting mechanisms are synchronously movable along the one of the at least one rail mechanism;
wherein during a period when the first suction mechanism and the at least one second suction mechanism suck the opposing edges of the flexible sheet body and when the two of the at least two cutting mechanisms cut the opposing edges of the flexible sheet body, the two strip-attaching mechanisms attach at least one strip on and along at least one of the opposing edges of the flexible sheet body.

2. The processing device of claim 1, wherein the first suction mechanism and the at least one second suction mechanism define a region therebetween, and the support platform is movable relative to the region.

3. The processing device of claim 1, wherein each of the two cutting mechanisms is angularly adjustable relative to at least one of the first direction and the second direction.

4. The processing device of claim 1, wherein the base, the first suction mechanism and the second suction mechanism are combinable with a base, a first suction mechanism and a second suction mechanism of another processing device, respectively.

5. The processing device of claim 1, wherein the first suction mechanism further includes a plurality of first recesses, and a bottom of each of the plurality of first recesses includes at least one of the plurality of first suction openings.

6. The processing device of claim 5, wherein the first suction mechanism further includes an upper wall, the plurality of first recesses are disposed on the upper wall, at least part of the plurality of first recesses includes a deep portion and a shallow portion, and depths of the deep portion and the shallow portion are less than or equal to 0.30 times a thickness of the upper wall.

7. The processing device of claim 6, wherein the deep portion is gradually deeper from a periphery of the first recess to the at least one of the plurality of first suction openings, and the shallow portion is gradually deeper from the periphery of the first recess to the at least one of the plurality of first suction openings.

8. The processing device of claim 6, wherein the first suction mechanism further includes a plurality of through holes disposed through the upper wall, and the plurality of through holes and the plurality of first suction openings are arranged side by side along the first direction.
